(19) United States
(12) Patent Application Publication
(10) Pub. No.: US 2024/0402834 A1
(43) Pub. Date: Dec. 5, 2024

(54) PROJECTION APPARATUS AND METHOD FOR CONTROLLING PROJECTION APPARATUS

(71) Applicant: Seiko EPSON Corporation, Tokyo (JP)

(72) Inventor: Yuki SUZUKI, Hiji-machi (JP)

(73) Assignee: Seiko EPSON Corporation, Tokyo (JP)

(21) Appl. No.: 18/677,478

(22) Filed: May 29, 2024

(30) Foreign Application Priority Data
May 30, 2023 (JP) 2023-088461

(51) Int. Cl. G06F 3/03; G09G 3/00

(52) U.S. Cl. CPC G06F 3/0304; G09G 3/001; G09G 2340/0464; G09G 2354/00

(57) ABSTRACT

A projection apparatus includes: a source search button and an AV mute button; a detector for detecting a first distance from a finger to the source search button and a second distance from the finger to the AV mute button; a projection unit that projects a source search button image representing the source search button and an AV mute button image representing the AV mute button, as a projection image; and a controller that controls display of the source search button image and the AV mute button image, and the controller causes a display mode of the source search button image to be different from a display mode of the AV mute button image when it is determined that the first distance is shorter than the second distance, based on an output from the detector.

The present application is based on, and claims priority from JP Application Serial Number 2023-088461, filed May 30, 2023, the disclosure of which is hereby incorporated by reference herein in its entirety.

### BACKGROUND

### 1. Technical Field

The present disclosure relates to a projection apparatus and a method for controlling the projection apparatus.

### 2. Related Art

JP-A-2019-133237 discloses a configuration of a projector including an operation panel including a menu button for displaying an OSD (on-screen display) menu screen for performing various settings, on a screen, a decision button for confirming an item selected on the OSD menu screen, and four direction buttons corresponding to up, down, left, and right. A controller causes a projection unit to display various menus and the like in response to an operation on the operation panel.

JP-A-2019-133237 is an example of the related art.

However, the configuration described in JP-A-2019-133237 has a problem in that, when a user performs an operation through the operation panel, the user needs to perform the operation while alternately viewing the operation panel and the screen and therefore needs to switch between targets of viewing, which is troublesome.

### SUMMARY

A projection apparatus for projecting a projection image onto a projection target includes a first operator and a second operator for operating the projection apparatus, a sensor for detecting a first distance from a pointer to the first operator and a second distance from the pointer to the second operator, a projection mechanism for projecting a first operation image representing the first operator and a second operation image representing the second operator, as the projection image, and one or a plurality of processors that control display of the first operation image and the second operation image, and the one or plurality of processors cause a display mode of the first operation image to be different from a display mode of the second operation image when it is determined that the first distance is shorter than the second distance, based on an output from the sensor.

A method for controlling a projection apparatus is provided, in which the projection apparatus includes a first operator and a second operator for operating the projection apparatus, and a sensor for detecting a first distance from a pointer to the first operator and a second distance from the pointer to the second operator, and projects a projection image onto a projection target, and the method includes: causing a projection mechanism to project a first operation image representing the first operator and a second operation image representing the second operator, as the projection image; and causing a display mode of the first operation image to be different from a display mode of the second operation image when it is determined that the first distance is shorter than the second distance, based on an output from the sensor.

### BRIEF DESCRIPTION OF THE DRAWINGS

FIG. 1 is a schematic diagram showing the configuration of a projector.

FIG. 2 is a schematic diagram showing the configuration of the projector.

FIG. 3 is a plan view illustrating the configuration of an operation panel.

FIG. 4 is a block diagram showing the electrical configuration of the projector.

FIG. 5 is a flowchart showing a method for controlling the projector.

FIG. 6 is a schematic diagram showing the method for controlling the projector.

FIG. 7 is a schematic diagram showing another example of the method for controlling the projector.

FIG. 8 is a schematic diagram showing another example of the method for controlling the projector.

FIG. 9 is a schematic diagram showing another example of the method for controlling the projector.

FIG. 10 is a schematic diagram showing another example of the method for controlling the projector.

FIG. 11 is a schematic diagram showing another example of the method for controlling the projector.

### DESCRIPTION OF EMBODIMENTS

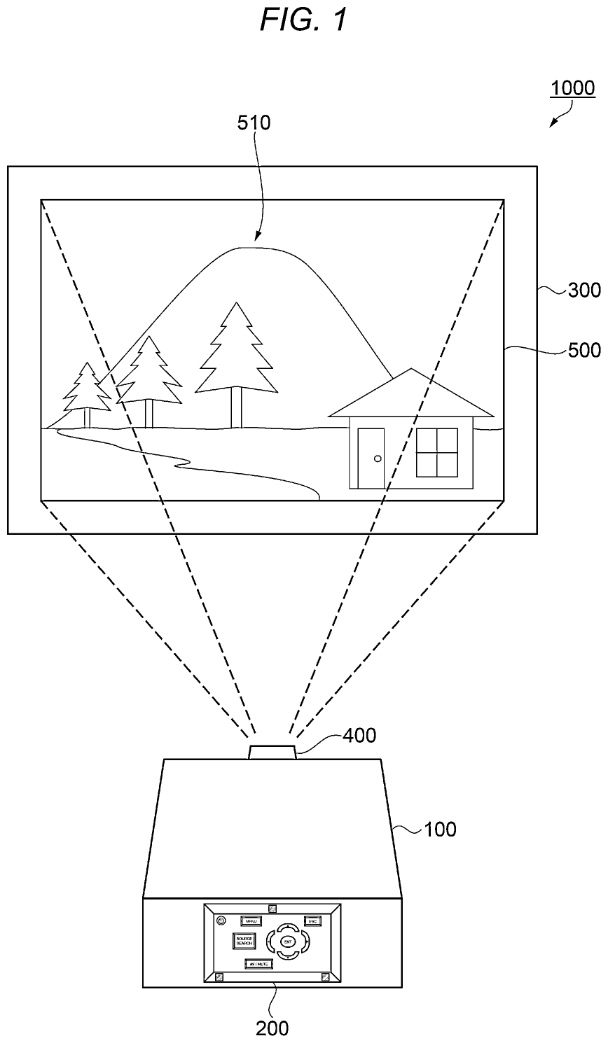

First, the configuration of a projector 1000 as a projection apparatus will be described with reference to FIGS. 1 to 3.

As shown in FIG. 1, the projector 1000 has a main body 100 and an operation panel 200 disposed in the main body 100.

The main body 100 has, for example, a projection unit 400 as a projection mechanism that projects image information or the like inputted from outside onto a projection surface 300 as a projection target. A projection image 500 based on the image information is displayed on the projection surface 300. Examples of the projection surface 300 include a screen and a whiteboard or the like.

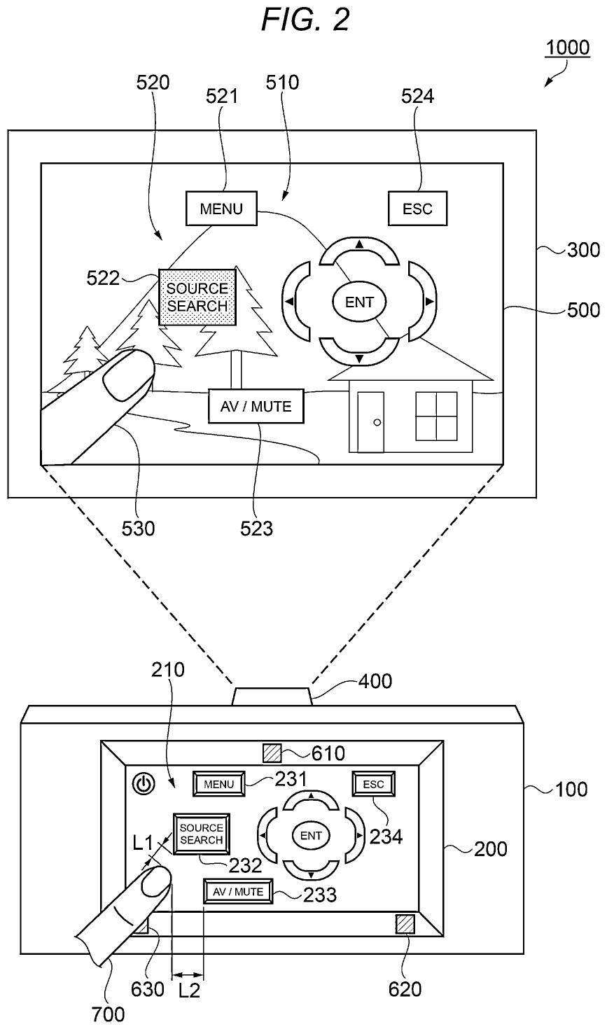

As illustrated in FIG. 2, the projection image 500 includes, for example, a content image 510 inputted from an external device, an operation image 520 showing a plurality of operation buttons 210 of the operation panel 200, and a pointer image 530 indicating a finger 700 of a user as a pointer. The operation image 520 and the pointer image 530 are projected onto the projection surface 300 as a part of the projection image 500 when the finger 700 approaches the operation panel 200 of the main body 100.

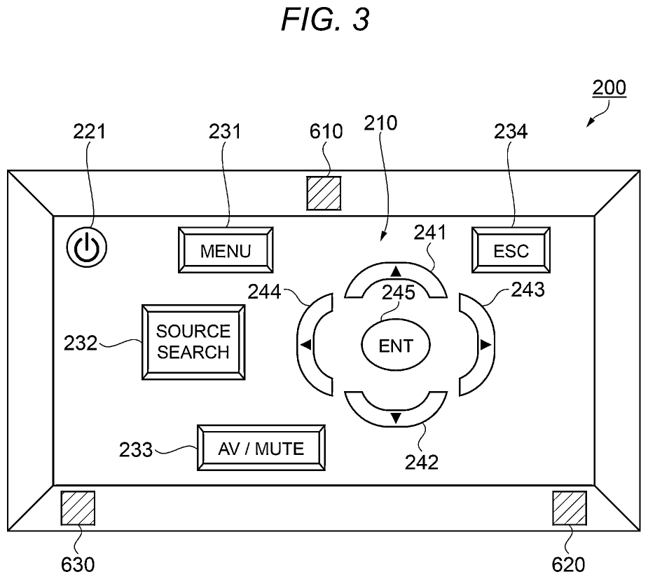

As shown in FIG. 3, the plurality of operation buttons 210 arranged on the operation panel 200 include, for example, a power button 221, a menu button 231, a source search button 232 as a first operator, an AV mute button 233 as a second operator, an escape button 234, an up button 241, a down button 242, a right button 243, a left button 244, and an enter button 245.

The operator is a physical button or a button on a touch panel or the like. The operation button 210 is operated by the finger 700 as a pointer. The pointer is not limited to the finger 700 and may be a pointer stick or the like.

Also, the proximity sensors 610, 620, 630 that detect that the finger 700 approaches the operation button 210 of the operation panel 200 are arranged around the operation panel 200. The proximity sensors 610 to 630 may preferably be arranged to surround the operation button 210. The number of the proximity sensors 610 to 630 is not limited to three and may be four or more or may be one.

Each of the proximity sensors 610 to 630 is, for example, an infrared optical sensor, and includes a light emitting element that emits an infrared ray and a light receiving element that receives light and converts the light into an electrical signal. The light receiving element receives a reflected infrared ray and converts the infrared ray into electric power, and determines that the finger 700 is within a predetermined distance when the converted electric power is equal to or greater than a predetermined value. As the three proximity sensors 610 to 630 are arranged, which operation button 210 the finger 700 is closest to can be detected. The proximity sensors 610 to 630 are not limited to optical sensors and may be, for example, sensors using a magnetic field, electrostatic capacitance, or image recognition.

As shown in FIG. 2, the operation image 520 has a menu button image 521 showing the menu button 231 as an image, a source search button image 522 showing the source search button 232 as an image, an AV mute button image 523 showing the AV mute button 233 as an image, and an escape button image 524 showing the escape button 234 as an image, and is projected on the projection surface 300. Also, the pointer image 530 showing the finger 700 as an image is projected on the projection surface 300.

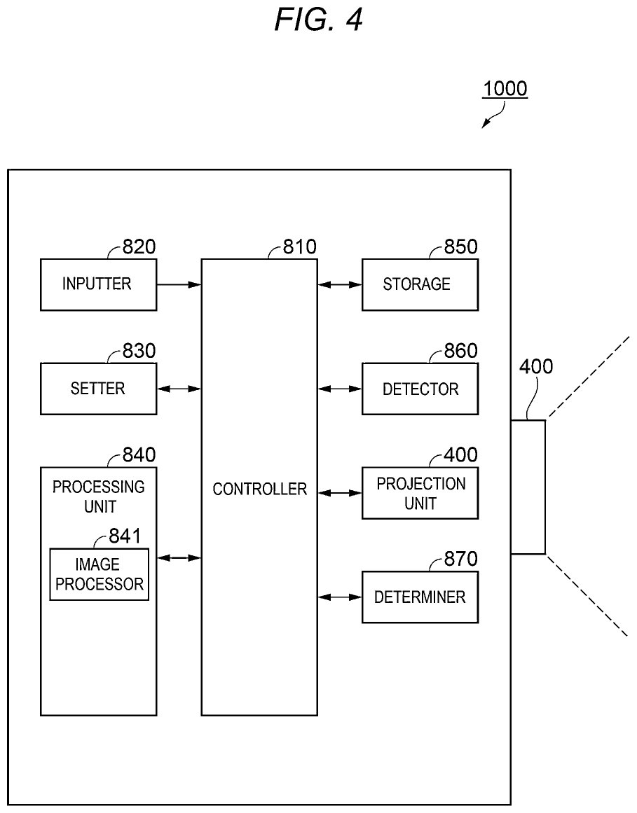

Next, the electrical configuration of the projector 1000 will be described with reference to FIG. 4.

As illustrated in FIG. 4, the projector 1000 has a controller 810, an inputter 820, a setter 830, a processing unit 840, a storage 850, a detector 860 as a sensor, the projection unit 400, and a determiner 870.

The controller 810 has one or a plurality of processors, and operates in accordance with a control program stored in the storage 850 and thus comprehensively controls the operation of the projector 1000. The controller 810 also controls the display of a first operation image or a second operation image, which is one of the operation images 520. In this embodiment, the first operation image is, for example, the source search button image 522. The second operation image is, for example, the AV mute button image 523 (see FIG. 2).

The inputter 820 has, for example, a plurality of input terminals such as HDMI (registered trademark) and USB terminals, is coupled to a computer, an image reproducing device, or the like, and receives supply of image information and audio information. The inputter 820 also receives an operation of the operation button 210 of the operation panel 200 and receives information about which cable is coupled. At least a part of the functions of the inputter 820 may be provided in the controller 810.

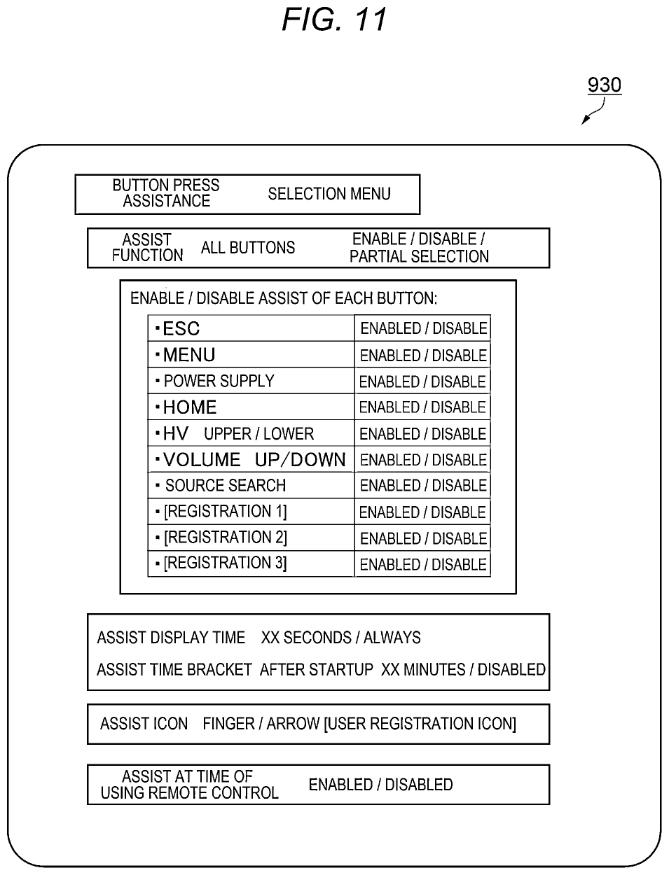

The setter 830 sets, for example, whether to project the operation image 520 or not, when the detector 860 detects that the finger 700 approaches the operation button 210, or whether to change the display mode of the operation image 520 or not (see FIG. 11). The setter 830 may also configure initial settings or the like of the projector 1000. At least a part of the functions of the setter 830 may be provided in the controller 810.

The processing unit 840 has an image processor 841. For example, when the detector 860 detects that the finger 700 approaches the operation button 210, the image processor 841 processes the image in such a way that the operation image 520 can be superimposed on the projected content image 510. When the finger 700 approaches any of the operation buttons 210, the image processor 841 performs processing of changing the display mode of the operation image 520. The processing unit 840 executes various processing based on an instruction from the controller 810. At least a part of the functions of the processing unit 840 may be provided in the controller 810.

The storage 850 has memories such as a RAM (Random-Access Memory) and a ROM (Read-Only Memory). The RAM is used to temporarily store various data and the like, and the ROM stores a control program, control data and the like for controlling the operation of the projector 1000. The storage 850 also stores information such as the operation image 520 to be projected from the projection unit 400. At least a part of the functions of the storage 850 may be provided in the controller 810.

The detector 860 has, for example, three proximity sensors 610 to 630. The detector 860 can detect which operation button 210 the finger 700 is closest to. Specifically, as shown in FIG. 2, the detector 860 detects a first distance L1 from the finger 700 to the source search button 232 and a second distance L2 from the finger 700 to the AV mute button 233. At least a part of the functions of the detector 860 may be provided in the controller 810.

The detector 860 is not limited to being formed of the three proximity sensors 610 to 630 and may be formed of two or fewer proximity sensors or may be formed of four or more proximity sensors. The output from one or a plurality of sensors, that is, the detector 860, refers to the number of outputs corresponding to the number of detectors 860.

Although not illustrated, the projection unit 400 has a light source, a liquid crystal light valve serving as a light modulation device, a projection optical system, a light valve driver, and the like. The projection unit 400 modulates light emitted from the light source with the liquid crystal light valve to form image light, projects the image light from the projection optical system including at least one of a lens and a mirror, and thus displays the projection image 500 on the projection surface 300.

The determiner 870 determines which operation button 210 the finger 700 is closest to, for example, based on the first distance L1 and the second distance L2 detected by the detector 860. The determiner 870 also determines which operation button 210 the finger 700 is facing, or which operation button 210 the finger 700 is approaching. At least a part of the functions of the determiner 870 may be provided in the controller 810.

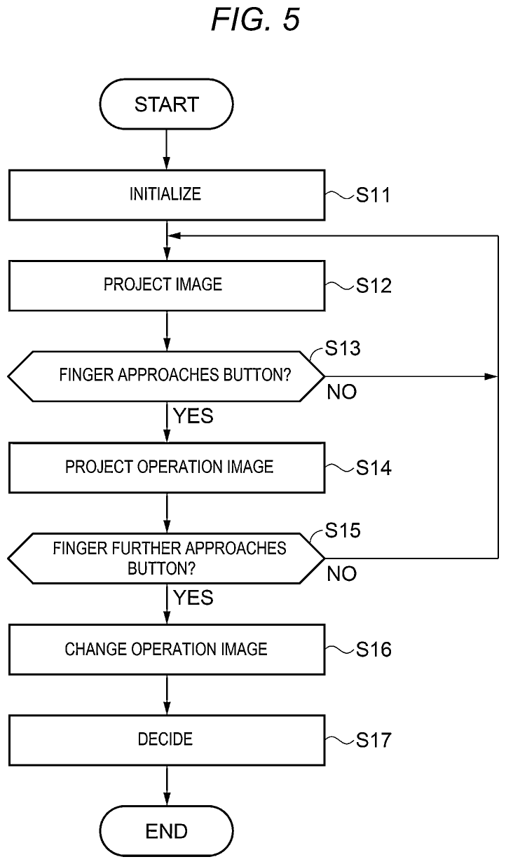

Next, an example of a method for controlling the projector 1000 according to this embodiment will be described with reference to FIGS. 5 to 7. In this embodiment, an example where the source search button 232 as the first operator is pressed from among the operation buttons 210 is described.

As shown in FIG. 5, first, in step S11, the projector 1000 is initialized. Specifically, the controller 810 reads and executes the initialization data stored in the storage 850.

Next, in step S12, the content image 510 is projected onto the projection surface 300. Specifically, the controller 810 causes the projection unit 400 to project image information from an external device inputted to the inputter 820. Thus, as illustrated in FIG. 1, the content image 510 is projected on the projection surface 300.

Next, in step S13, it is determined whether the finger 700 approaches the operation button 210 of the operation panel 200 or not. Specifically, the controller 810 causes the detector 860 to detect the distance between the finger 700 and the operation button 210, and causes the determiner 870 to determine whether the distance between the finger 700 and the operation button 210 is shorter than a predetermined distance. The predetermined distance is determined in advance based on an experiment, simulation, or the like. When the finger approaches the operation button (YES in step S13), the processing proceeds to step S14. When the finger is not approaching the operation button (NO in step S13), the processing proceeds to step S12 and the content image 510 continues to be projected.

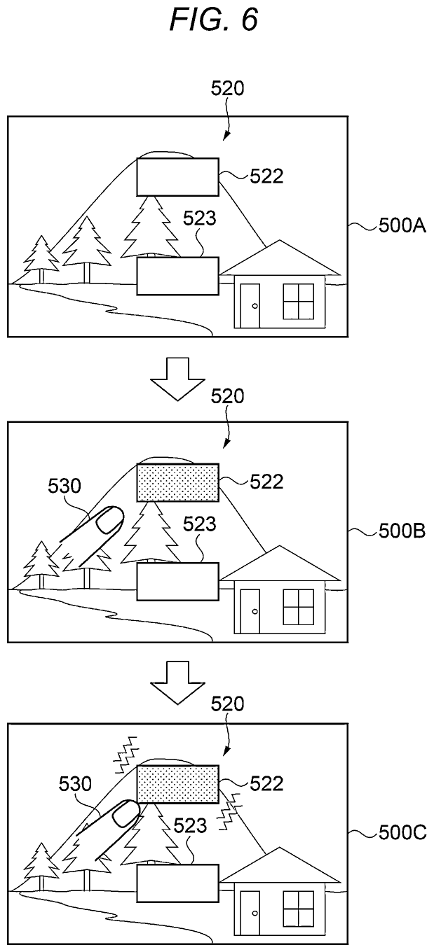

Next, in step S14, a projection image 500A with the operation image 520 added is projected onto the projection surface 300. That is, as shown in FIG. 6, the operation image 520 is superimposed on the content image 510 to be displayed. Specifically, the controller 810 reads data of the operation image 520 from the storage 850 and causes the projection unit 400 to project the projection image 500A.

The controller 810 may cause the projection unit 400 to simultaneously display the pointer image 530 as shown in a projection image 500B, or to display the pointer image 530 when the finger 700 is closer to the operation button 210. As shown in the projection images 500B, 500C, it is preferable that the pointer image 530 moves according to the movement of the finger 700.

As the pointer image 530 is thus projected in addition to the source search button image 522 and the AV mute button image 523, the user can grasp whether the finger 700 is approaching the source search button 232 or the AV mute button 233, by viewing the projected projection image 500. Thus, when the operation button 210 which the user originally wants to operate is the source search button 232, an erroneous operation of the AV mute button 233 can be suppressed. That is, the user can operate the desired operation button 210 among the plurality of operation buttons 210, based on the result of observation of the pointer image 530.

The controller 810 causes the image processor 841 to process the projection images 500B, 500C in such a way that the distance between the operation image 520 and the pointer image 530 matches the distance relationship between the operation button 210 and the finger 700, based on the information of the first distance L1 and the second distance L2 detected by the detector 860.

In this embodiment, since the finger 700 approaches the source search button 232 when the user is about to press the source search button 232, the first distance L1 between the finger 700 and the source search button 232 is shorter than the second distance L2 between the finger 700 and the AV mute button 233, as shown in FIG. 2.

Thus, the controller 810 causes the image processor 841 to perform image processing in such a way that the display mode of the source search button image 522 is more highlighted than the AV mute button image 523, based on the information of the distances L1, L2. The display mode of the source search button image 522 may change with time according to the distance between the finger 700 and the source search button 232.

As an example of the change with time, for example, as the finger 700 becomes closer to the source search button 232, the blinking cycle of the source search button image 522 becomes shorter, the transmittance becomes lower, and the frequency of vibration becomes higher, or the like.

Thus, the user can recognize that the finger 700 is near the source search button 232, without actually viewing the source search button 232. Therefore, the user can operate the source search button 232 simply by viewing the projected operation image 520 without feeling the trouble of viewing the source search button 232 or the source search button image 522.

In other words, even in an environment where the surroundings of the projector 1000 are dark and it is difficult for the user to visually recognize the operation panel 200, the user can operate the desired operation button 210. Although the method of pressing the source search button 232 has been described in this embodiment, this is not limiting and another operation button 210 may be pressed.

Next, in step S15, it is determined whether the finger 700 further approaches the source search button 232 or not. Specifically, when the determiner 870 determines that the first distance L1 detected by the detector 860 is even shorter (YES in step S15), the controller 810 shifts the processing to step S16. When the first distance L1 is not shortened (NO in step S15), the processing returns to step S12 to project the content image 510.

Next, in step S16, as shown in the projection image 500C, the display mode of the source search button image 522 is more highlighted. Specifically, the controller 810 causes the image processor 841 to perform image processing in such a way that, for example, the source search button image 522 wiggles. Thus, the user can recognize that the finger 700 is closer to the source search button 232.

Next, in step S17, the source search button 232 is pressed to determine on source search, and predetermined processing is subsequently performed. The flow of the method for controlling the projector 1000 is thus ended. After the source search button 232 is pressed in step S17, the processing may return to step S12.

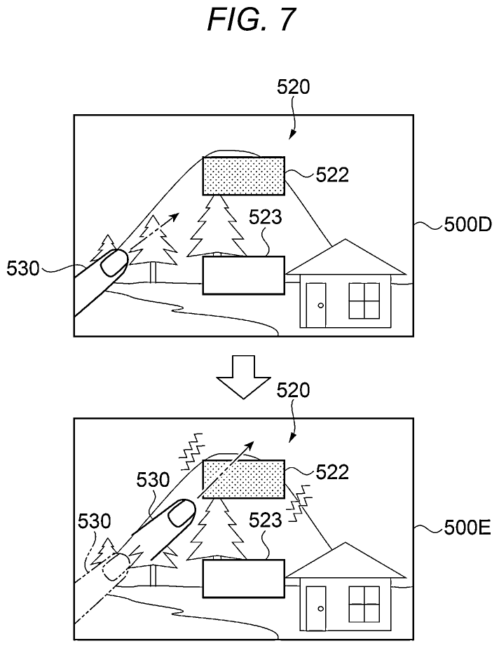

Next, another example of the method for controlling the projector 1000 according to this embodiment will be described with reference to FIG. 7.

In this example, an example where the operation button 210 located in the direction indicated by the finger 700 is recognized will be described. That is, as shown in a projected projection image 500D, the display mode of the source search button image 522 indicated by the pointer image 530 is highlighted. In this case, the pointer image 530 is closer to the AV mute button image 523, but the source search button image 522 is highlighted. That is, the controller 810 may collect and analyze the output signal from the detector 860 and transmit the result of the analysis to the image processor 841, and the image processor 841 may change the display mode according to vector information of the finger 700 instead of simply according to the distance, based on the result of the analysis.

Next, as shown in a projection image 500E, when the finger 700 approaches the source search button 232, for example, the display mode is highlighted further and the source search button image 522 is displayed in such a way as to wiggle. The image processor 841 may increase the frequency of vibration of the source search button image 522 as the distance between the finger 700 and the source search button 232 decreases.

According to such a control method, whether the direction of the operation button 210 indicated by the finger 700 is correct or not can be recognized, without being affected by the distance between the finger 700 and the operation button 210.

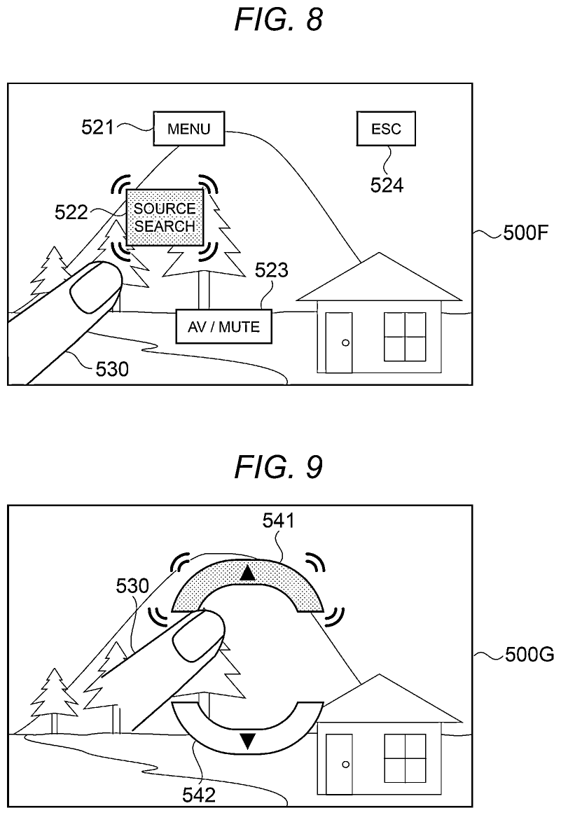

Next, another example of the method for controlling the projector 1000 according to this embodiment will be described with reference to FIGS. 8 and 9.

In this example, a method in which, when the operation button 210 is selected to proceed to the subsequent selection image, the operation image 520 displayed in a projection image 500G is switched and is displayed in an easy-to-view manner, is described.

In a projection image 500F illustrated in FIG. 8, the source search button image 522 is selected and executed, using the method according to the above-described embodiment. Next, in the projection image 500G illustrated in FIG. 9, the decision of the source search shifts to a further level, and an up button image 541 and a down button image 542 are displayed as buttons to be selected. That is, the direction button images 541, 542 are not displayed until the level of the menu shifts to the level where the direction button images 541, 542 are actually used.

In the projection image 500G, when selecting the upward direction, when the finger 700 is brought close to the up button 241, the display mode of the up button image 541 indicating the up button 241 is highlighted and this enables the recognition that the finger 700 approaches the up button 241.

As the projection images 500F, 500G are thus displayed, the relevant operation images 520 are displayed without displaying all the operation images 520, and therefore the images are simple, easy to view, and easy to operate. Also, since the necessary operation image 520 is displayed, erroneous pressing can be suppressed.

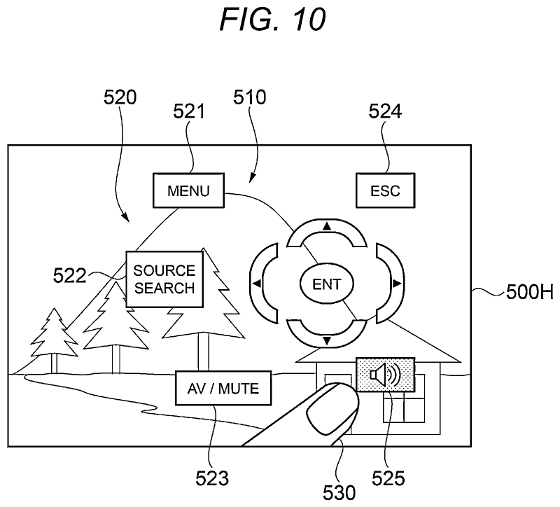

Next, another example of the method for controlling the projector 1000 according to this embodiment will be described with reference to FIG. 10.

In this example, when the finger 700 is brought close to a space where the operation button 210 is not arranged on the operation panel 200, as shown in a projection image 500H, a virtual sound output button image 525, which is not arranged as the operation button 210, is displayed in the projection image 500H.

Specifically, the virtual sound output button image 525 is set in advance to be displayed in the projection image 500H when the finger 700 is brought close to a certain region on the operation panel 200, as illustrated in FIG. 10. By tapping the sound output button image 525, the user can determine on the processing though the user does not experience the sense of actually pressing the button.

According to such a method, though the sense of pressing the button is not given, the space on the operation panel 200 can be effectively utilized and an operation which is not provided on the operation panel 200 can be easily performed.

Next, another example of the method for controlling the projector 1000 according to this embodiment will be described with reference to FIG. 11. FIG. 11 illustrates a screen displayed as apart of the projection image 500 and used to set an assistance for the operation image 520 in the method for controlling the projector 1000.

The setting of this function may be configured at the beginning of the flow of the method for controlling the projector 1000 or may be configured at the user's timing. Also, the operation may be performed from the menu button 231.

As in a projection image 930 illustrated in FIG. 11, the setting of the operation image 520 including a plurality of menu items is displayed as a button press assistance selection menu. As the assist function, whether to enable or disable the display of the operation image 520 corresponding to the operation button 210 can be selected. When a change operation of changing the level of the menu item is accepted, the operation image 520 is switched between display and non-display according to the level.

Also, an assist display time, that is, the time for displaying the operation image 520, can be set. In addition, an assist icon, that is, a finger or an arrow to show the pointer image 530, can be selected. Also, a setting such that the assist display is not performed when the remote controller is used may be configured.

As described above, the projector 1000 according to this embodiment is the projector 1000 projecting the projection image 500 onto the projection surface 300, and has the source search button 232 and the AV mute button 233 for operating the projector 1000, the detector 860 for detecting the first distance L1 from the finger 700 to the source search button 232 and the second distance L2 from the finger 700 to the AV mute button 233, the projection unit 400 projecting the source search button image 522 representing the source search button 232 and the AV mute button image 523 representing the AV mute button 233, as the projection image 500, and the controller 810 controlling the display mode of the source search button image 522 and the AV mute button image 523, and the controller 810 causes the display mode of the source search button image 522 to be different from the AV mute button image 523 when it is determined that the first distance L1 is shorter than the second distance L2, based on the output from the detector 860.

According to this configuration, since the display mode of the operation image 520 corresponding to the operation button 210 which the finger 700 approaches is made different, the position of the source search button 232 can be specified without actually viewing the source search button 232 or the AV mute button 233. Thus, the user can operate the source search button 232 simply by viewing the projected operation image 520 without feeling the trouble of viewing the source search button 232 or the source search button image 522.

That is, the user can move the finger 700 to the operation button 210 without looking away from the operation image 520. Also, even in a dark environment, the user can press the operation button 210. Further, even in a narrow space, the user can press the operation button 210.

In the projector 1000 according to this embodiment, the controller 810 may preferably cause the projection unit 400 to project the pointer image 530 representing the finger 700 as the projection image 500, based on the output from the detector 860. According to this configuration, since the pointer image 530 is projected in addition to the source search button image 522 and the AV mute button image 523, the user can grasp whether the finger 700 is approaching the source search button 232 or the AV mute button 233, by viewing the projected projection image 500. This allows the user to quickly operate the source search button 232.

In the projector 1000 according to this embodiment, the controller 810 may preferably move the pointer image 530 in accordance with the movement of the finger 700, based on the output from the detector 860. According to this configuration, the pointer image 530 is moved and therefore the user can check the situation and can grasp whether the finger 700 is approaching the source search button 232 or not.

In the projector 1000 according to this embodiment, the controller 810 may preferably change the display mode of the source search button image 522 with time according to the first distance L1, based on the output from the detector 860. According to this configuration, since the display mode of the source search button image 522 is changed with time, the user can easily grasp whether the finger 700 approaches the source search button 232 or not, by observing the projected source search button image 522.

In the projector 1000 according to this embodiment, the controller 810 may preferably change the display mode of the source search button image 522 with time according to the direction of movement of the finger 700, based on the output from the detector 860. As for the direction of movement of the finger 700, for example, the controller 810 collects and analyzes the output signal from the detector 860 and transmits the result of the analysis to the image processor 841, and the image processor 841 changes the display mode of the source search button image 522 according to the direction of movement of the finger 700, based on the result of the analysis. More specifically, the controller 810 determines the position of the finger 700 at each predetermined time point, based on the output signal from the detector 860. Then, the direction of movement of the finger 700 is estimated from the positions of the finger 700 determined at least at two time points. According to this configuration, since the display mode of the source search button image 522 is changed with time according to the direction of movement of the finger 700, the user can easily grasp whether the finger 700 is moving toward the source search button 232 or moving in another direction, by observing the display mode of the operation image 520.

The projector 1000 according to this embodiment has the main body 100 in which the source search button 232 and the AV mute button 233 are arranged, and the positional relationship between the source search button image 522 and the AV mute button image 523 may preferably be the same as the positional relationship between the source search button 232 and the AV mute button 233 in the main body 100. According to this configuration, the positional relationship between the source search button image 522 and the AV mute button image 523 is the same as the positional relationship between the source search button 232 and the AV mute button 233 in the main body 100, and therefore for the user, the sense of operating the source search button image 522 and the AV mute button image 523 matches the sense of operating the main body 100 and the operability can be improved.

In the projector 1000 according to this embodiment, the controller 810 may preferably cause the projection unit 400 to project the projection image 930 including a plurality of menu items, as the projection image 500, may accept a change operation of changing the level of the menu items, and may switch the source search button image 522 and the AV mute button image 523 between display and non-display according to the level. According to this configuration, since the operation image 520 is displayed or not displayed according to the level, the configuration of the projection image 500 can be optimized by not displaying the operation image 520 for the menu item at the level where the operation image 520 need not be displayed, or the like.

The method for controlling the projector 1000 according to the embodiment is a method for controlling the projector 1000 having the source search button 232 and the AV mute button 233 for operating the projector 1000, and the detector 860 for detecting the first distance L1 from the finger 700 to the source search button 232 and the second distance L2 from the finger 700 to the AV mute button 233, and projecting the projection image 500 on the projection surface 300, and the method includes: causing the projection unit 400 to project the source search button image 522 representing the source search button 232 and the AV mute button image 523 representing the AV mute button 233, as the projection image 500; and causing the display mode of the source search button image 522 to be different from the display mode of the AV mute button image 523 when it is determined that the first distance L1 is shorter than the second distance L2, based on the output from the detector 860.

According to this method, since the display mode of the operation image 520 which the finger 700 approaches is made different, the position of the source search button 232 can be specified without actually viewing the source search button 232 or the AV mute button 233. Therefore, the user can operate the source search button 232 simply by viewing the projected operation image 520 without feeling the trouble of viewing the source search button 232 or the source search button image 522.

Modification examples of the above-described embodiment will be described below.

The arrangement of the operation images 520 is not limited to matching the arrangement of the operation buttons 210 on the operation panel 200, as described above, and the operation images 520 may be displayed differently from the arrangement of the operation buttons 210.

Specifically, the arrangement of the plurality of operation images 520 can be set by the user, and for example, when the top-and-bottom setting of the projector 1000 is changed, the top-and-bottom setting of the plurality of operation images 520 may preferably be changed accordingly.

In this way, in the projector 1000 according to the modification example, the controller 810 may preferably accept the change operation for changing the arrangement of the source search button image 522 and the AV mute button image 523, and may change the positions of the source search button image 522 and the AV mute button image 523 in relation to the projection surface 300 in response to the change operation. According to this configuration, since the positions of the source search button image 522 and the AV mute button image 523 are changed in response to the change operation, for example, when the projector 1000 is installed upside down, the operation image 520 can be arranged at a position where it is easy for the user to view the operation image 520.

The summary of the present disclosure is given below as appendices.

(Appendix 1) A projection apparatus for projecting a projection image onto a projection target, includes: a first operator and a second operator for operating the projection apparatus; a sensor for detecting a first distance from a pointer to the first operator and a second distance from the pointer to the second operator; a projection mechanism that projects a first operation image representing the first operator and a second operation image representing the second operator, as the projection image; and one or a plurality of processors that control display of the first operation image and the second operation image, and the one or plurality of processors cause a display mode of the first operation image to be different from a display mode of the second operation image when it is determined that the first distance is shorter than the second distance, based on an output from the sensor.

According to this configuration, since the display mode of the operation image corresponding to the operator to which the pointer approaches is made different, the position of the first operator can be specified without actually viewing the first operator or the second operator. Thus, the user can operate the first operator simply by viewing the projected operation image and without repeating the operation of switching the target of viewing from one of the first operator and the first operation image to the other. That is, the user can operate the projection apparatus without feeling the trouble of switching the target of viewing to operate the projection apparatus.

(Appendix 2) In the projection apparatus according to Appendix 1, the one or plurality of processors cause the projection mechanism to project a pointer image representing the pointer, as the projection image, based on an output from the sensor.

According to this configuration, since the pointer image is projected in addition to the first operation image and the second operation image, the user can grasp whether the pointer is approaching the first operator or the second operator, by viewing the projected image. Thus, the user can operate the desired first operator, based on the result of observation of the pointer image.

(Appendix 3) In the projection apparatus according to Appendix 2, the one or plurality of processors move the pointer image in accordance with a movement of the pointer, based on an output from the sensor. According to this configuration, since the pointer image is moved, the user can check the movement and can grasp whether the pointer is approaching the first operator or not.

(Appendix 4) In the projection apparatus according to any one of Appendices 1 to 3, the one or plurality of processors change the display mode of the first operation image with time according to the first distance, based on an output from the sensor. According to this configuration, since the display mode of the first operation image is changed with time, the user can easily grasp whether the pointer approaches the first operator or not, by observing the projected first operation image.

(Appendix 5) In the projection apparatus according to any one of Appendices 1 to 4, the one or plurality of processors change the display mode of the first operation image with time according to a direction of movement of the pointer, based on an output from the sensor. According to this configuration, since the display mode of the first operation image is changed with time according to the direction of movement of the pointer, the user can easily grasp whether the pointer is moving toward the first operator or moving in another direction, by observing the display mode of the operation image.

(Appendix 6) In the projection apparatus according to any one of Appendices 1 to 5, the one or plurality of processors accept a change operation for changing an arrangement of the first operation image and the second operation image, and change positions of the first operation image and the second operation image in relation to the projection target in response to the change operation. According to this configuration, since the positions of the first operation image and the second operation image are changed in response to the change operation, for example, when the projection apparatus is installed upside down, the operation image can be arranged at a position where it is easy for the user to view the operation image.

(Appendix 7) The projection apparatus according to any one of Appendices 1 to 6 further includes a main body in which the first operator and the second operator are arranged, and a positional relationship between the first operation image and the second operation image is the same as a positional relationship between the first operator and the second operator in the main body. According to this configuration, the positional relationship between the first operation image and the second operation image is the same as the positional relationship between the first operator and the second operator in the main body, and therefore for the user, the sense of operating the first operation image and the second operation image matches the sense of operating the main body and the operability can be improved.

(Appendix 8) In the projection apparatus according to any one of Appendices 1 to 7, the one or plurality of processors cause the projection mechanism to project a plurality of menu items as the projection image, accept a change operation of changing a level of the menu items, and switch the first operation image and the second operation image between display and non-display, according to the level. According to this configuration, since the operation image is displayed or not displayed according to the level, the configuration of the projection image can be optimized by not displaying the operation image for the menu item at the level where the operation image need not be displayed, or the like.

(Appendix 9) A method for controlling a projection apparatus is provided, in which the projection apparatus includes a first operator and a second operator for operating the projection apparatus, and a sensor for detecting a first distance from a pointer to the first operator and a second distance from the pointer to the second operator, and projects a projection image onto a projection target, and the method includes: causing a projection mechanism to project a first operation image representing the first operator and a second operation image representing the second operator, as the projection image; and causing a display mode of the first operation image to be different from a display mode of the second operation image when it is determined that the first distance is shorter than the second distance, based on an output from the sensor.

According to this method, since the display mode of the operation image corresponding to the operator to which the pointer approaches is made different, the position of the first operator can be specified without actually viewing the first operator or the second operator. Thus, the user can operate the first operator simply by viewing the projected operation image and without repeating the operation of switching the target of viewing from one of the first operator and the first operation image to the other. That is, the user can operate the projection apparatus without feeling the trouble of switching the target of viewing to operate the projection apparatus.

What is claimed is:

1. A projection apparatus for projecting a projection image onto a projection target, the projection apparatus comprising:
a first operator and a second operator for operating the projection apparatus;
a sensor for detecting a first distance from a pointer to the first operator and a second distance from the pointer to the second operator;
a projection mechanism that projects a first operation image representing the first operator and a second operation image representing the second operator, as the projection image; and
one or a plurality of processors that control display of the first operation image and the second operation image, wherein
the one or plurality of processors cause a display mode of the first operation image to be different from a display mode of the second operation image when it is determined that the first distance is shorter than the second distance, based on an output from the sensor.

2. The projection apparatus according to claim 1, wherein
the one or plurality of processors cause the projection mechanism to project a pointer image representing the pointer, as the projection image, based on an output from the sensor.

3. The projection apparatus according to claim 2, wherein
the one or plurality of processors move the pointer image in accordance with a movement of the pointer, based on an output from the sensor.

4. The projection apparatus according to claim 1, wherein
the one or plurality of processors change the display mode of the first operation image with time according to the first distance, based on an output from the sensor.

5. The projection apparatus according to claim 1, wherein
the one or plurality of processors change the display mode of the first operation image with time according to a direction of movement of the pointer, based on an output from the sensor.

6. The projection apparatus according to claim 1, wherein
the one or plurality of processors
accept a change operation for changing an arrangement of the first operation image and the second operation image, and
change positions of the first operation image and the second operation image in relation to the projection target in response to the change operation.

7. The projection apparatus according to claim 1, further comprising:
a main body in which the first operator and the second operator are arranged, wherein
a positional relationship between the first operation image and the second operation image is the same as a positional relationship between the first operator and the second operator in the main body.

8. The projection apparatus according to claim 1, wherein
the one or plurality of processors
cause the projection mechanism to project a plurality of menu items as the projection image,
accept a change operation of changing a level of the menu items, and
switch the first operation image and the second operation image between display and non-display, according to the level.

9. A method for controlling a projection apparatus, the projection apparatus comprising a first operator and a second operator for operating the projection apparatus, and a sensor for detecting a first distance from a pointer to the first operator and a second distance from the pointer to the second operator, the projection apparatus projecting a projection image onto a projection target, the method comprising:
causing a projection mechanism to project a first operation image representing the first operator and a second operation image representing the second operator, as the projection image; and
causing a display mode of the first operation image to be different from a display mode of the second operation image when it is determined that the first distance is shorter than the second distance, based on an output from the sensor.
